(19) United States
(12) Patent Application Publication
(10) Pub. No.: US 2006/0005975 A1
(43) Pub. Date: Jan. 12, 2006

(54) Firefighting system

(75) Inventors: Charles Louis Bissat, Lillooet (CA); Bruce Hubert Janning, Lillooet (CA)

Correspondence Address: ANTONY C. EDWARDS, SUITE 200 - 270 HIGHWAY 33 WEST, KELOWNA, BC, V1X 1X7, CA

(73) Assignee: AQUA-RACK ENTERPRISES, LILLOOET (CA)

(21) Appl. No.: 10/527,749

(22) PCT Filed: Sep. 30, 2003
(86) PCT No.: PCT/CA03/01498

§ 371 Date: Mar. 14, 2005

Related U.S. Application Data
(60) Provisional application No. 60/414,703, filed on Oct. 1, 2002.

(51) Int. Cl. A62C 25/00

(52) U.S. Cl. 169/51; 239/195

(57) ABSTRACT

A fire fighting system includes a rack having open sides for carrying sprinklers on the outsides and hoses within. The rack has a generally enclosed pair of rigid ends, a lower rigid floor and an upper rigid brace, wherein the of rigid ends are mounted in spaced apart relation on opposite ends of the floor and the brace. Releasable mounting means are mounted on the pair of rigid ends for releasably mounting a plurality of elongate sprinklers across said apart sides of the open sides of the rack so as to form, when the sprinklers are mounted thereon, rigid side walls covering the spaced apart sides of the open sides. This defines an enclosed storage cavity within the rack bounded by the ends, the side walls, the floor and the brace. The storage cavity is sized for storage of the coiled hoses therein.

### FIELD OF THE INVENTION

This invention relates to the field of devices for fighting fires and in particular to an improved system for transporting and deploying an array of water sprinklers.

### BACKGROUND OF THE INVENTION

It is known in the prior art such as International Patent Application No. PCT/FR90/00971 having an International Publication No. W091/09649 published Jul. 11, 1991, for an Automatic Device for Fighting Forrest Fires, to provide a supply of pressurized water through conduits such as buried pipes to supply a plurality of columns on top of which are mounted water diffusers.

It is also known in the prior art to use water sprinklers as a defensive measure to protect buildings and property from the encroachment of fire for example as disclosed in U.S. Pat. No. 3,576,212 which issued Apr. 27, 1971 to Siler for a Fire-Shielding Device, U.S. Pat. No. 5, 165,482 which issued Nov. 24, 1992 to Smagac et al. for A Fire Deterrent System For Structures in a Wildfire Hazard Area, U.S. Pat. No. 5,692,571 which issued Dec. 2, 1997 to Jackson for a Building Exterior Fire Prevention System, and U.S. Pat. No. 6,360,968 which issued Mar. 26,2002 to Orrange et al. for A Wildfire Protection System

What is not addressed in the prior art is the need to be able to manually transport firefighting sprinklers and the corresponding hoses and couplings from a crew access point such as a helicopter landing zone through the brush to the location of the fire break along which fire suppression sprinklers may be employed. In the prior art of which applicant is aware in the field of manually transportable fire suppression devices, applicant is only aware of the fire suppressor, which basically comprises a tank containing fire suppressant configured to be worn by a user as disclosed in U.S. Pat. No. 5,0180,584 which issued May 28, 1991 to Tomlinson for a Fire Suppressor.

In the prior art relating to carrying devices, applicant is aware of U.S. Pat. No. 4,526,414 which issued Jul. 2, 1995 to Jones for a Foldable Carrying Device, and U.S. Pat. No. 4,779,914 which issued Oct. 25, 1988 to Friedline for a Display and Carrying Rack for Fishing Equipment, neither of which devices are adapted for carrying fire suppression equipment in the manner disclosed herein.

### SUMMARY OF THE INVENTION

In summary, the fire fighting system of the present invention includes a rack having open sides for carrying sprinklers on the outsides and hoses within. The rack has a generally enclosed pair of rigid ends, a lower rigid floor and an upper rigid brace, wherein the pair of rigid ends are mounted in spaced apart relation on opposite ends of the floor and the brace. Releasable mounting means are mounted on the pair of rigid ends for releasably mounting a plurality of elongate sprinklers across spaced apart sides of the open sides of die rack so as to form, when the sprinklers are mounted thereon, rigid side walls covering the spaced apart sides of the open sides.

This defines an enclosed storage cavity within the rack bounded by the ends, the side walls, the floor and the brace. The storage cavity is sized for storage of the coiled hoses therein In one embodiment the rigid ends are each generally planar and are substantially parallel to one another. Oppositely disposed pairs of cantilevered members may be mounted to and extend from the pair of rigid ends for releasable mounting of water-flow diverting T-couplers thereon. The pairs of cantilevered members may be parallel elongate prongs.

The releasable mounting means may include a plurality of resilient clamps mounted in oppositely disposed relation to opposite edges of the ends. The clamps may include a spaced apart array of clamps mounted along each side edge of the edges of the ends. Each end may be generally triangular. The brace may be mounted at a vertex of each end. The brace may be adapted to form a carrying handle. A flexible shoulder strap may be mounted at its ends to the rigid ends, for example at the vertex of each end.

The floor may form a concave shelf and may be a mesh.

The ends may be spaced apart a distance so that, advantageously, distal ends of the pairs of cantilevered members, distal from the rigid ends, do not extend beyond the opposite ends of the sprinklers when mounted in the releasable mounting means.

### BRIEF DESCRIPTION OF THE DRAWINGS

FIG. 1 is, in partially exploded view, the firefighting system according to the present invention.

FIG. 2 is, in non exploded side view, the firefighting system of FIG. 1.

FIG. 3a is, in side elevation view, the rack of the firefighting system according to FIG. 1.

FIG. 3b is, in end elevation view, the rack of FIG. 3a FIG. 4a is, in side elevation view, a stack of the racks according to FIG. 3a.

FIG. 4b is, in end elevation view, the stack of lacks of FIG. 4a.

FIG. 5a is, in front elevation view, one of the water sprinklers of the firefighting system according to FIG. 1.

FIG. 5b is, in side elevation view, the water sprinkler of FIG. 5a.

FIG. 6a is, in front elevation view, a hose T-coupling of the firefighting system according to FIG. 1.

FIG. 6b is, in side elevation view, the T-coupling of FIG. 6a.

### DETAILED DESCRIPTION OF EMBODIMENTS OF THE INVENTION

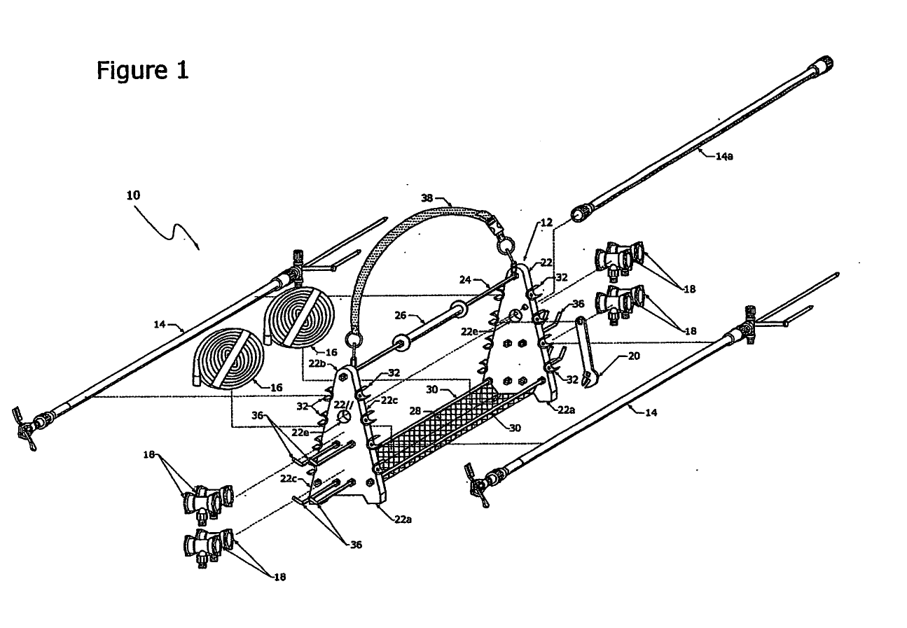

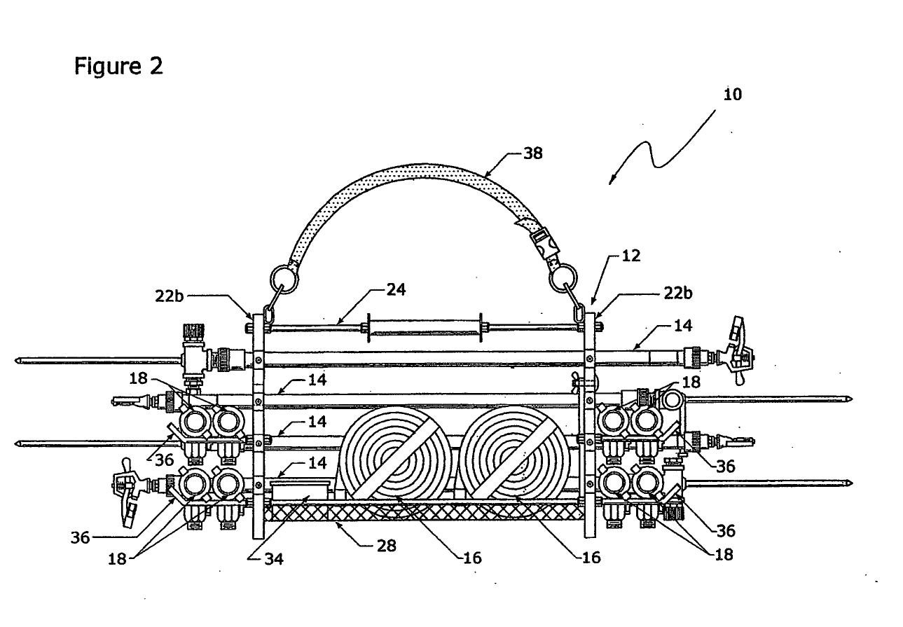

As seen in FIGS. 1 and 2, the fire fighting system 10 according to the present invention includes a rack 12 for carrying water sprinklers 14, hoses 16, T-couplers 18 so called “water thieves”, and tools such as wrench 20.

Rack 12 has generally triangular plates 22 disposed vertically at opposite ends of an upper rigid carrying member 24 having a handle 26 mounted thereon, and a lower basket channel 28 mounted to, so as to extend between a pair of rigid supporting struts 30 mounted to end plates 22 so as to extend therebetween parallel to carrying member 24. End plates 22 are disposed so that their wider ends 22a form a base and feet for the rack when resting on the ground, and where the pointed or vertex ends 22b of their triangular shape are at the upper end of the rack corresponding to carrying member 24. Side edges 22c extend along the perimeter of the triangular shape of end plates 22 so as to extend between vertex ends 22b and wider ends 22a Resilient clips 32 are mounted in spaced apart array along side edges 22c aligned so as to releasably secure the tubular posts of sprinklers 14 when resiliently clipped in parallel array into opposite pairs of clips 32 on opposite end plates 22. Thus in the embodiment of FIG. 1, rack 12 may hold up to eight sprinklers 14 clipped into clips 32, it being understood that in FIG. 1 only two sprinklers 14 are shown for mounting in clips 32, and in FIG. 2,only four sprinklers 14 are shown mounted along one side of rack 12 so as to not clutter the views. However, with four sprinklers 14 mounted on each side of end plates 22, a central storage cavity is defined bounded by the sprinklers 14, end plates 22, basket channel 28, and carrying member 24.

As seen in FIG. 2, rolled up hoses 16 may be stored in basket channel 28 as also may be other items such as small container 34. Although not intended to be limiting, it is not necessary that T-couplers 18 be stored for transport and storage within basket channel 28 as cantilevered members 36 pairs of cantilevered members are mounted to end plates 22 so that each pair extends horizontally from each end plate 22 between the ends of sprinklers 14 extending from clips 32. In the embodiment illustrated, members 36 are long enough so as to support thereon two T-couplers 18 in sliding engagement between and on each pair of cantilevered members 36.

Consequently, in the embodiment illustrated because two pairs of cantilevered members extend from each end plate 22, in oppositely disposed relation, a total of eight T-couplers 18 may be mounted thereon. As illustrated, each cantilevered member 36 may have an upturned end so as to inhibit T-couplers 18 from sliding off the cantilevered members.

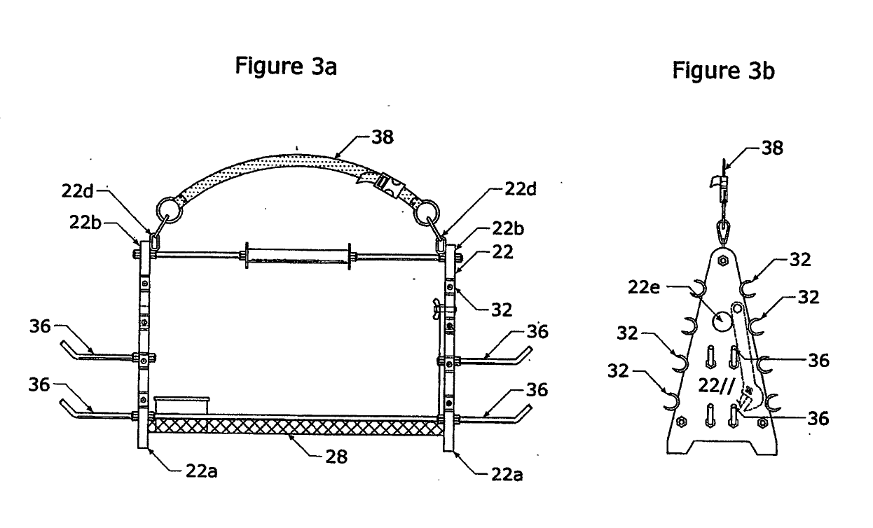

As also seen in FIGS. 3a and 3b, a flexible and releasably mounted shoulder strap 38 may be clipped to securing points 22d mounted to vertex ends 22b of end plates 22. An aperture 22e may be provided in end plates 22 for example for carrying journalled therethrough a spare sprinkler tube 14a.

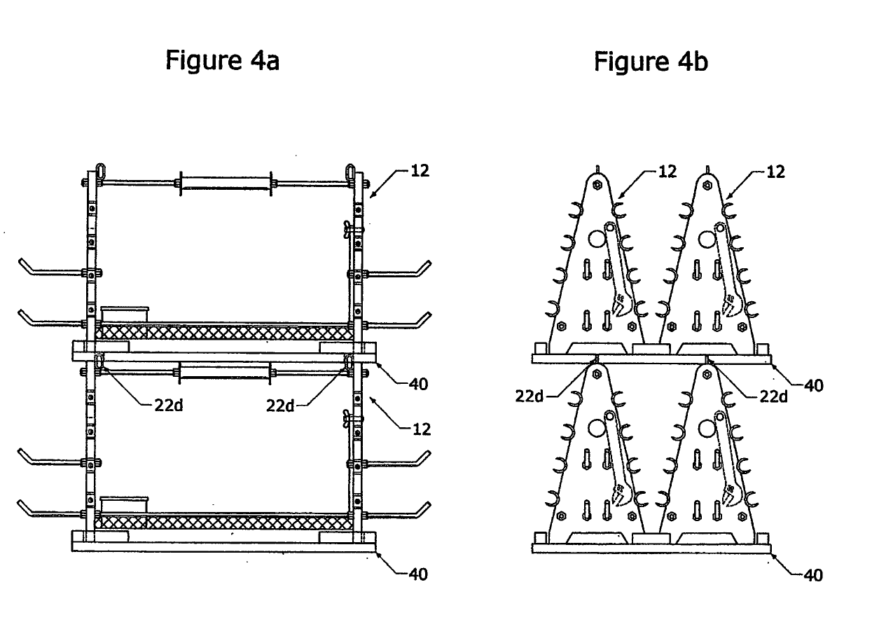

As seen in FIGS. 4a and 4b, racks 12 may be stacked for storage of the fire fighting systems of the present invention by, in the illustrated embodiment, mounting a pair of racks 12 onto a supporting platform 40 so as to vertically stack pairs of racks 12 on top of each other. Such vertical stacks may be stabilized by interlocking securing points 22d, which in the illustrated embodiments are oval rings rigidly mounted to vertex ends 22b so as to protrude upwardly therefrom, with corresponding apertures or grooves formed in the underside of platforms 40.

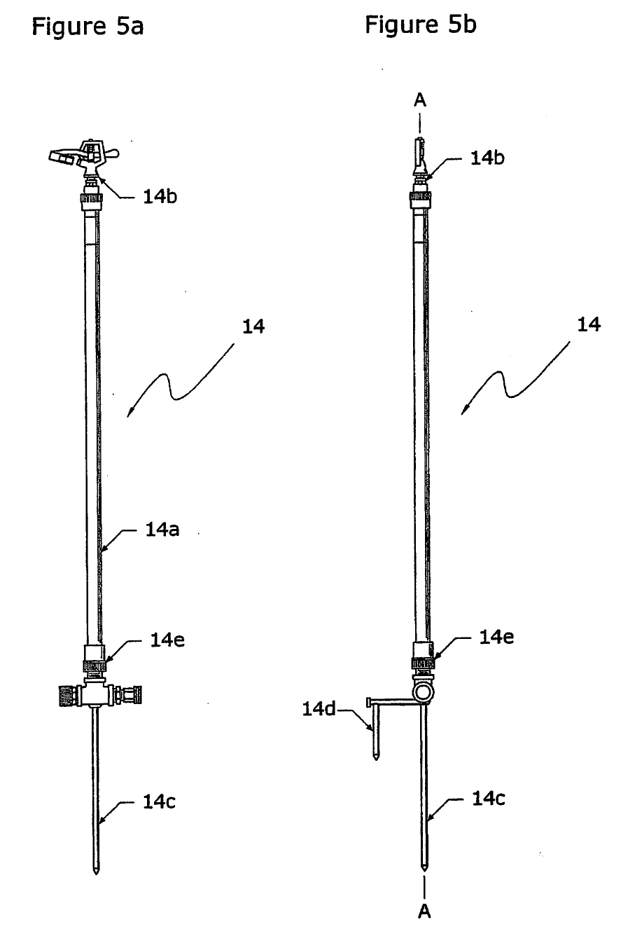

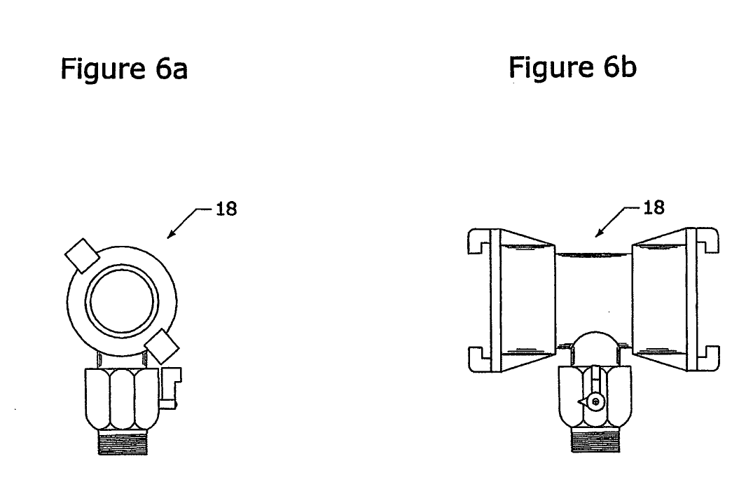

As seen in FIGS. 5a and 5b, each sprinkler 14 includes a cylindrical tube 14a having removably mounted on one end a sprinkler head 14b and at an opposite end a ground mounting device such as bayonet 14c. An auxiliary anchor bayonet 14d may be rigidly mounted to, spaced from, bayonet 14c so as to prevent rotation of sprinkler 14 about its longitudinal axis A when mounted in the ground. Hose couplers 14e provide for mounting sprinklers 14 between lengths of water supply hose 16. T-couplers 18 such as better seen in FIGS. 6a and 6b, may be employed to divert water along branch lines so as to supply water to a spaced apart pattern of a plurality of water sprinklers 14.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A fire fighting system comprising:
a rack having open sides, said rack having a generally enclosed pair of rigid ends, a lower rigid floor and an upper rigid brace, wherein said pair of rigid ends are mounted in spaced apart relation on opposite ends of said floor and said brace,
releasable mounting means mounted on said pair of rigid ends for releasably mounting a plurality of elongate sprinklers across spaced apart sides of said open sides of said rack so as to form, when said sprinklers are mounted thereon, rigid side walls covering said spaced apart sides of said open sides, thereby defining an enclosed storage cavity within said rack bounded by said ends, said side walls, said floor and said brace, wherein said storage cavity is sized for storage of coiled hoses therein.

2. The system of claim 1 wherein said rigid ends are each generally planar.

3. The system of claim 2 wherein said rigid ends are substantially parallel to one another.

4. The system of claim 1 further comprising oppositely disposed pairs of cantilevered members mounted to and extending from said pair of rigid ends for releasable mounting of water-flow diverting T-couplers thereon.

5. The system of claim 3 wherein said pairs of cantilevered members are parallel elongate prongs.

6. The system of claim 1 wherein said floor is a mesh.

7. The system of claim 2 wherein said releasable mounting means includes a plurality of resilient clamps mounted in oppositely disposed relation to opposite edges of said ends.

8. The system of claim 1 wherein said floor forms a concave shelf.

9. The system of claim 1 wherein said brace is adapted to form a carrying handle.

10. The system of claim 9 further comprising a flexible shoulder strap mounted at its ends to said rigid ends.

11. The system of claim 7 wherein said clamps include a spaced apart array of clamps mounted along each side edge of said edges of said ends.

12. The system of claim 11 wherein each said end is generally triangular, said brace mounted at a vertex of each said end.

13. The system of claim 4 wherein said ends are spaced apart a distance so that distal ends of said pairs of cantilevered members distal from said rigid ends, do not extend beyond the opposite ends of the sprinklers when mounted in said releasable mounting means.

14. The system of claim 4 wherein said releasable mounting means includes a plurality of resilient clamps mounted in oppositely disposed relation to opposite edges of said ends.

15. The system of claim 14 wherein said ends are spaced apart a distance so that distal ends of said pairs of cantilevered members distal from said rigid ends, do not extend beyond the opposite ends of the sprinklers when mounted in said releasable mounting means.

16. The system of claim 15 wherein said pairs of cantilevered members are parallel elongate prongs.

17. The system of claim 16 wherein said rigid ends are each generally planar.

18. The system of claim 17 wherein said rigid ends are substantially parallel to one another.
